(19) United States
(12) Patent Application Publication
(10) Pub. No.: US 2019/0239421 A1
(43) Pub. Date: Aug. 8, 2019

(54) HERBICIDE APPLICATION DEVICE AND METHOD FOR ROW CROP CULTIVATION

(71) Applicant: Green no-till, LLC, Indianapolis, IN (US)

(72) Inventor: Michael H. Fritsch, Indianapolis, IN (US)

(21) Appl. No.: 16/267,732

(22) Filed: Feb. 5, 2019

Related U.S. Application Data
(60) Provisional application No. 62/628,049, filed on Feb. 8, 2018.

(51) Int. Cl. A01C 7/08; A01M 21/04

(52) U.S. Cl. CPC A01C 7/08; A01M 21/043

(57) ABSTRACT

A method for row crop cultivation in an agricultural plot includes providing a cover crop on a majority of the agricultural plot prior to planting a row crop, and applying an herbicide to the cover crop within a plurality of row crop planting stripes. The method also includes using an herbicide application device to limit application of the herbicide to the plurality of row crop planting stripes, planting row crop seedlings within the row crop planting stripes, and preserving the cover crop between the plurality of row crop planting stripes during cultivation of the row crop.

### CROSS-REFERENCE TO RELATED APPLICATIONS

This application claims the benefit of U.S. Provisional Patent Application No. 62/628,049, filed Feb. 8, 2018.

### TECHNICAL FIELD

The present disclosure relates generally to row crop cultivation on an agricultural plot and, more particularly, to maintaining a cover crop on the agricultural plot while cultivating the row crop.

### BACKGROUND

A problem with current agricultural crop cultivation is that the ground is prepared each year by tilling and disking, and then smoothing and seeding. During this process, the ground and soil architecture are disrupted, with the disruption causing a degradation in soil aeration, composition, microbial and invertebrate losses, water permeability issues, and erosion.

One current remedy for the problems associated with the tillage type agricultural techniques is to use “no-till” and “drilling” techniques. In this type of cultivation, there is no tillage done to disrupt the ground architecture, resulting in a more natural and conserved soil profile. According to a particular technique, weeds may be permitted to grow until just prior to planting. At that time, an herbicide is applied to “burn-down” the weeds. Once the weeds have been killed and the herbicide is no longer active, the crop seeds may be “drilled” into the ground in narrow furrows.

In an attempt to improve the soil, a technique that incorporates “cover-crops” has been used. The cover-crop is usually a clover, grass, radish, or annual plant, for example, that is placed broadly over the field to “cover it.” It is sewn into the soil just after or during harvest time and is allowed to grow for several months, sometimes over winter into the next spring. The benefits of using a cover crop may include adding more organic matter to the soil, aerating, accumulating nitrogen, conserving the soil structure, building the soil, and suppressing weeds by out-competing the weeds.

Most of these cover crop benefits end, however, with the pre-planting herbicide “burn-down.” That is, the entire field of cover crop is eliminated and the field turns brown and withered. At that point, the drilling is performed and the seeds are planted. This “no-till” technique leaves the agricultural area susceptible to weed invasion by eliminating the cover crop at “burn-time” time. Additionally, the nitrogen gathering abilities, soil aeration, and other benefits of the cover crops are also halted.

### SUMMARY OF THE INVENTION

In one aspect, a method for row crop cultivation in an agricultural plot includes providing a cover crop on a majority of the agricultural plot prior to planting a row crop, and applying an herbicide to the cover crop within a plurality of row crop planting stripes. The method also includes using an herbicide application device to limit application of the herbicide to the plurality of row crop planting stripes, using vertical blades for defining the row crop planting stripes underground, planting row crop seedlings within the row crop planting stripes, and preserving the cover crop between the plurality of row crop furrow planting stripes during cultivation of the row crop.

In another aspect, an herbicide application device for row crop cultivation in an agricultural plot is provided. The agricultural plot includes a cover crop and designated crop cultivation zones including a plurality of row crop planting stripes. The herbicide application device includes an implement frame supporting a feeder pipe providing herbicide to the herbicide application device from a tank or other source. The herbicide application device also includes a set of parallel, straight blades supported by the implement frame configured to cut underground roots entering row crop planting stripes, and a shield sized and configured to shield the cover crop from herbicide applied to the row crop planting stripes.

Other features and aspects will be apparent from the following description and accompanying drawings.

### BRIEF DESCRIPTION OF THE DRAWINGS

FIG. 1 is a top plan view of a cover crop provided over a majority of an exemplary agricultural plot, according to the present disclosure;

FIG. 2 is a top plan view similar to that of FIG. 1, with an herbicide applied to the cover crop within a plurality of row crop planting stripes, according to the present disclosure;

FIG. 3 is a top plan view, illustrating row crop seedlings planted in the plurality of row crop planting stripes, according to the present disclosure;

FIG. 4 is a cross-section view, sectioned through the soil, illustrating the cultivation of a row crop while also preserving the cover crop between the plurality of row crop planting stripes, according to the present disclosure;

FIG. 5 is a front/hind diagrammatic view of a portion of an exemplary herbicide application device, according to the present disclosure;

FIG. 6 is a front/hind diagrammatic view of a portion of another exemplary herbicide application device, according to the present disclosure;

FIG. 7 is a front/hind diagrammatic view of a portion of yet another exemplary herbicide application device, according to the present disclosure;

FIG. 8 is a partial diagrammatic view of an exemplary shield configured for use with a portion of an herbicide application device, according to the present disclosure;

FIG. 9 is a partially sectioned side diagrammatic view of another exemplary shield configured for use with an herbicide application device, according to the present disclosure;

FIG. 10 is a flow diagram illustrating a method for row crop cultivation, according to the present disclosure;

FIG. 11 is a front diagrammatic view of an exemplary herbicide application device including shields or plates;

FIG. 12 is a side diagrammatic view of the herbicide application device and shields or plates of FIG. 11;

FIG. 13 is a front diagrammatic view of an exemplary herbicide application device including a set of blades;

FIG. 14 is a side diagrammatic view of an exemplary disc blade that may be incorporated into an herbicide application device of the present disclosure; and

FIG. 15 is a side diagrammatic view of an exemplary straight blade that may be incorporated into an herbicide application device of the present disclosure.

### DETAILED DESCRIPTION

Reference will now be made in detail to specific embodiments or features, examples of which are illustrated in the accompanying drawings. Wherever possible, corresponding or similar reference numerals will be used throughout the disclosure and accompanying drawings to refer to the same or corresponding parts.

Turning now to FIG. 1, an exemplary method and system for row crop cultivation in an agricultural plot 10, as disclosed herein, is discussed. At an early stage in the cultivation process, a cover crop 12 may be provided over a majority, which may be at least half, of the exemplary agricultural plot 10. The cover crop 12 may be clover, grass, rye, radish, or other annual plant, for example, that may be planted as a thick mat of green to cover the agricultural plot 10. According to the present disclosure, an annual, perennial, or both may be planted as the cover crop 12.

If the cover crop 12 is perennial, it may continue to grow and proliferate year after year. Advantageously, if the perennial is preserved year after year, the initial expense of the cover crop may be diffused over time. Thus, it may become economical to plant a higher quality cover crop densely. Once the cover crop 12 is planted in the late summer or fall, it may be cared for as an actual crop. As such, the cover crop 12 may be an important addition to the soil improvement plan and also may itself be a useful crop that can be harvested.

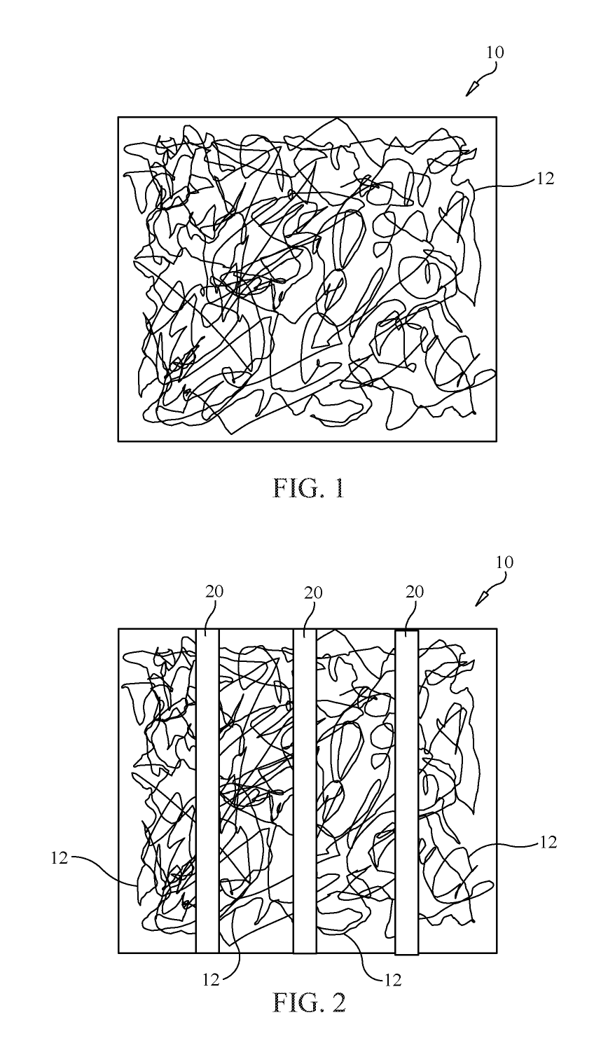

Turning now to FIG. 2, the present disclosure describes an exemplary method and system for preparing the row crop soil areas for new seed and plantings without damaging the entirety of the cover crop 12. The soil area where the “regular” row crop is to be planted can be imagined as parallel row crop planting stripes 20, or furrows, when viewed from above. According to an exemplary embodiment, these row crop planting stripes 20 may be approximately 4-6 inches wide, with 15-30 inches spaced between the row crop planting stripes 20. However, the present disclosure is applicable to alternative configurations and dimensions with regard to the agricultural plot 10.

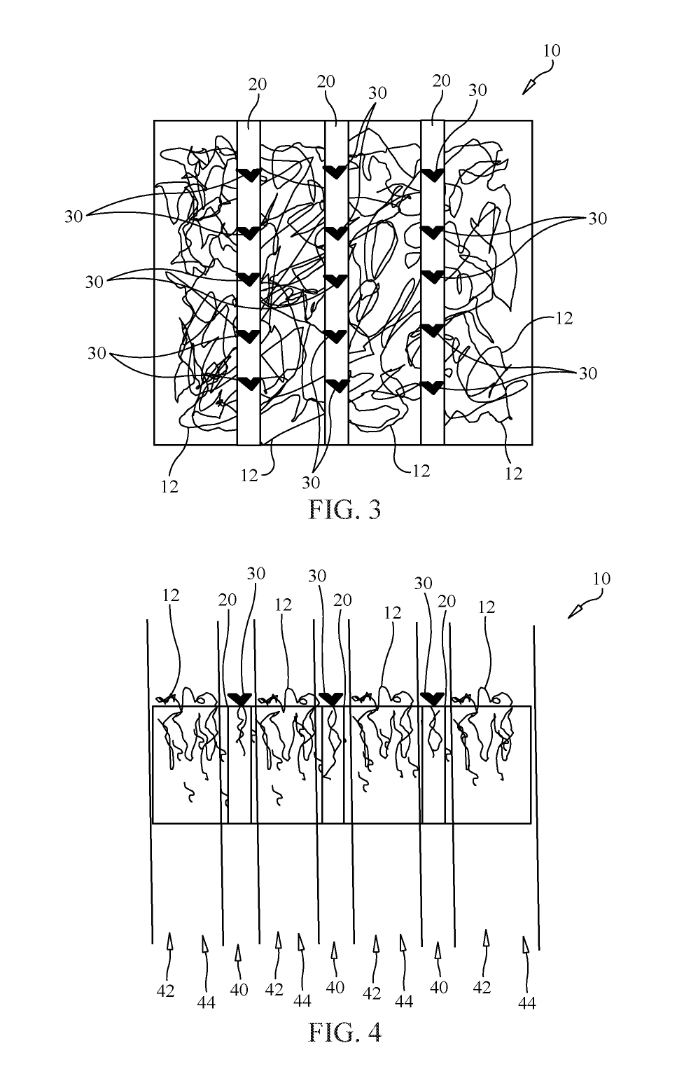

Referring also to FIG. 3, row crop seedlings 30 are shown placed or planted in the plurality of row crop planting stripes 20, or furrows. The parallel row crop planting stripes 20 may include or define the width and depth of soil needed by the row crop seedlings 30 to grow a root system and derive water and nutrients from the soil. The remaining soil area, between the row crop planting stripes 20, may continue to have actively growing cover crop 12 and may be used for row crop canopy expansion.

Referring also to FIG. 4, is a side view of the agricultural plot 10 described above, depicting herbicide zones 40 corresponding to the row crop planting stripes 20, and non-herbicide zones 42 corresponding to cover crop areas 44. As shown, sufficient space is provided for cultivation of the row crop seedlings 30, while also preserving the cover crop 12, and root structures, between the plurality of row crop planting stripes 20. That is, sufficient room exists for growth of both the row crop seedlings 30 and the cover crop 12.

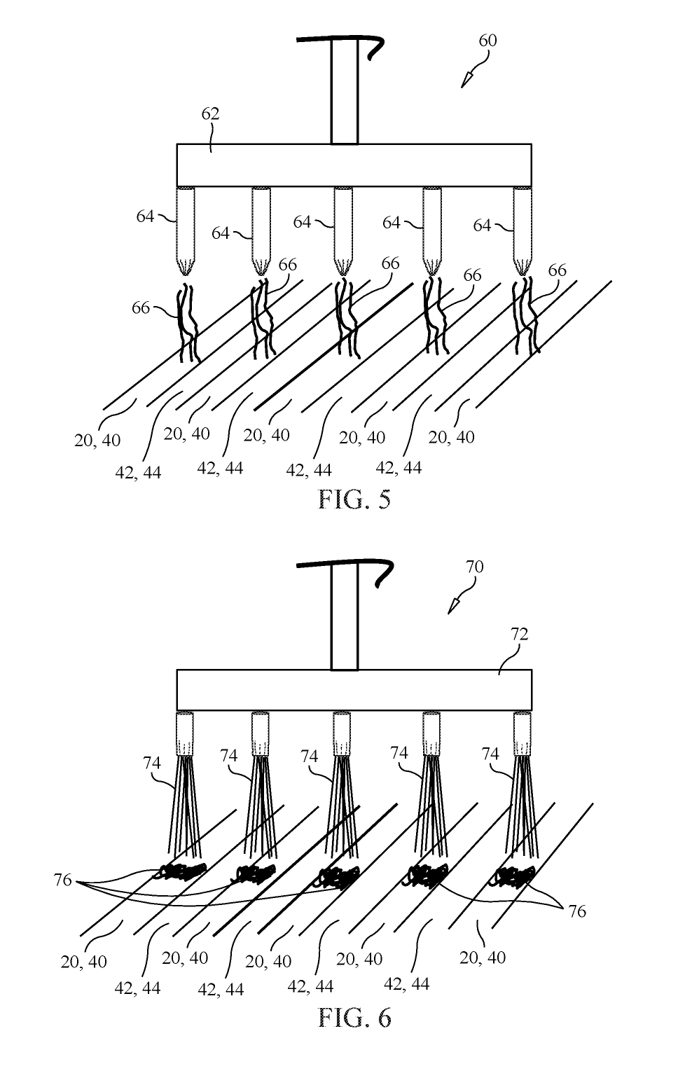

The present disclosure also describes an herbicide application device used to restrict or limit application of the herbicide to the plurality of row crop planting stripes 20, or herbicide zones 40, while also preserving, or shielding, cover crop areas 44 in the non-herbicide zones 42. Referring to FIG. 5, a portion of a first exemplary herbicide application device 60 may include a feeder pipe 62 providing herbicide to the herbicide application device 60 from a tank or other source. It should be appreciated that the herbicide application device 60, and herbicide tank, may be supported on and moved by a farm tractor or machine. The herbicide application device 60, which may also be referred to as an “implement” or “attachment,” may include a plurality of individual nozzles 64 configured for applying herbicide 66 at widths corresponding to respective row crop planting stripes 20. In particular, the herbicide application device 60 may be configured to restrict application of herbicide to respective row crop planting stripes 20, without applying herbicide 66 to the cover crop areas 44. Although a specific embodiment is shown, it should be appreciated that the herbicide application device 60 may include a larger number of nozzles 64 spanning across multiple alternating rows of row crop planting stripes 20 and cover crop areas 44.

Another exemplary embodiment of an herbicide application device 70 is shown generally in FIG. 6. Similar to the herbicide application device 60 of FIG. 5, the herbicide application device 70 of FIG. 6 may include a feeder pipe 72 providing herbicide to the herbicide application device 70 from a tank or other source. The herbicide application device 70 may include sets of bristles, or fibers, 74, which may be made from metal, or other suitable materials. The sets of bristles 74, which may or may not contact the soil on or near the row crop planting stripes 20 during use of the herbicide application device 70, may be configured to apply herbicide 76 at widths corresponding to respective row crop planting stripes 20. In particular, the herbicide application device 60 may be configured to restrict or limit herbicide application to respective row crop planting stripes 20, without applying herbicide 76 to the cover crop areas 44.

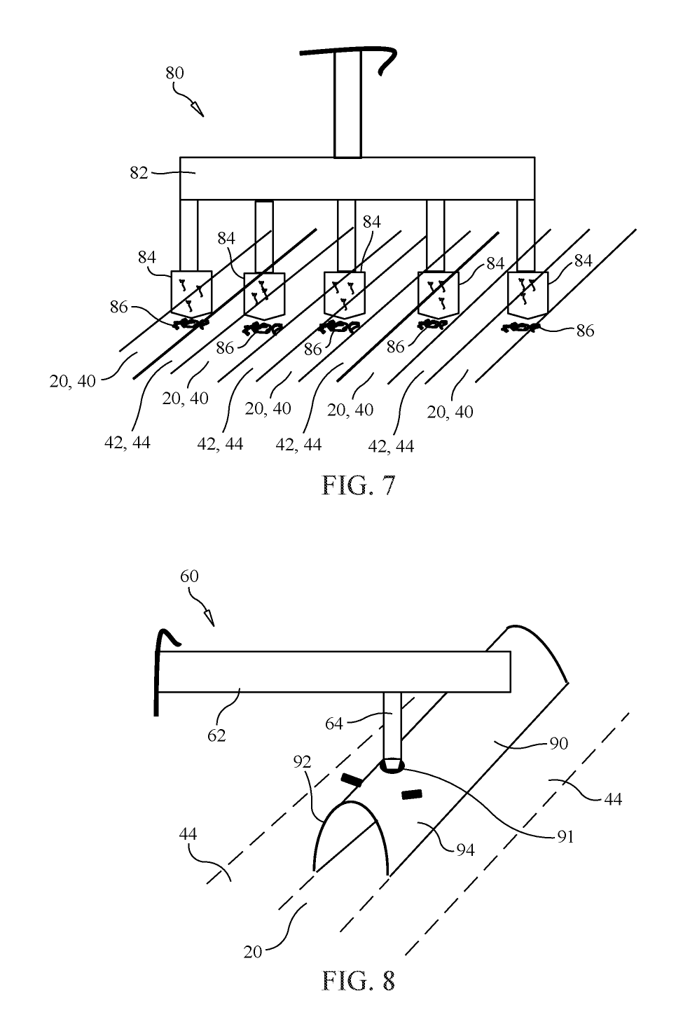

According to yet another exemplary embodiment, FIG. 7 illustrates a portion of an herbicide application device 80. The herbicide application device 80 may include a feeder pipe 82 providing herbicide to the herbicide application device 80 from a tank or other source. The herbicide application device 80 may include sets of wicks, such as strips of carpets or other material strips, 84. The sets of wicks 84 may be configured to apply herbicide 86 at widths corresponding to respective row crop planting stripes 20. In particular, the herbicide application device 80 may be configured to restrict or limit herbicide application to respective row crop planting stripes 20, without applying herbicide to the cover crop areas 44. The sets of wicks 84 may or may not contact the soil of the row crop planting stripes 20. The length of the wicks can be short or long enough to drag on the ground.

FIG. 8 depicts a shield 90 that may be used with any of the embodiments described herein and/or additional or alternative embodiments. The shield 90 may attach at any suitable location, using any known attachment means, relative to the herbicide application device 60, 70, 80 and may receive herbicide therethrough from the respective feeder pipe 62, 72, 74. For example, feeder pipe 64 of the herbicide application device 60 of FIG. 5 may provide herbicide through on opening 91 of the shield. The shield 90 may be sized and configured to shield the cover crop areas 44 from herbicide applied to the row crop planting stripes 20. That is, sides 92, 94 may be spaced apart a distance corresponding to a row crop planting stripe 20. The sides 92, 94 may or may not contact the soil during application.

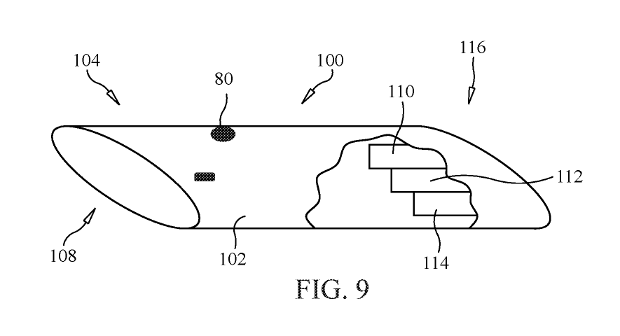

FIG. 9 depicts another exemplary embodiment of a shield 100 that may be used with the herbicide application devices 60, 70, 80. The shield 100 may include at least two sides 102, a top 104 and an opening 106 for receiving herbicide. The shield 100 may also include a sloped, or angled, front end 108 for easing movement of the shield 100 across the soil. The shield additionally may include one or more steps 110, 112, 114, which may be positioned within the shield 100 at a rear end 116 of the shield 100 and may urge herbicide entering through the opening 106 downward toward the soil. This further restricts the herbicide, in an aerosolized form or otherwise, to the row crop planting stripes 20.

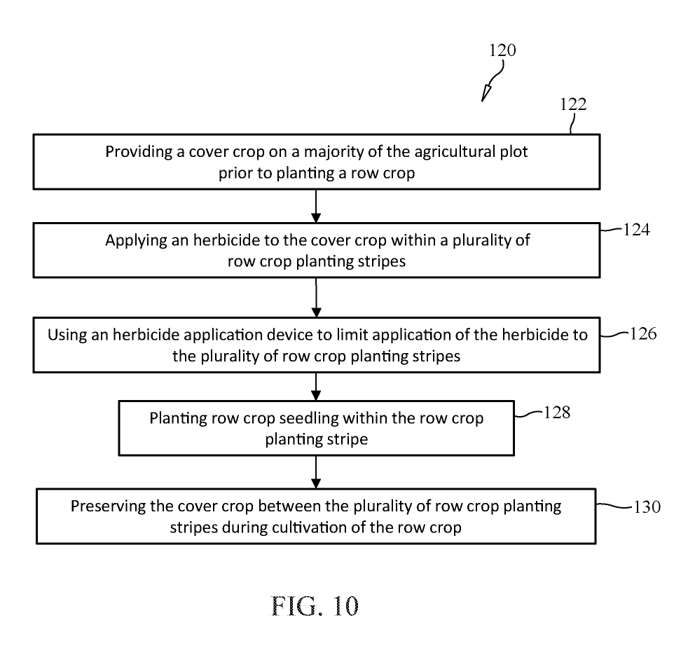

FIG. 10 illustrates a flow diagram 120 of an exemplary method of the present disclosure. At a first stage, at box 122, a cover crop 12 is provided on a majority of the agricultural plot 10 prior to planting a row crop 30. An herbicide is then applied only to portions of the cover crop 12 within the plurality of row crop planting stripes 20, at box 124. In particular, at box 126, an herbicide application device 60, 70, 80 and, according to some embodiments, the shield 90, 100 may be used to limit or restrict application of the herbicide to the plurality of row crop planting stripes 20. Next, row crop seedlings 30 are planted within the row crop planting stripes, at box 128, and the cover crop 12 is preserved between the plurality of row crop planting stripes 20 during cultivation of the row crop 30, at box 130.

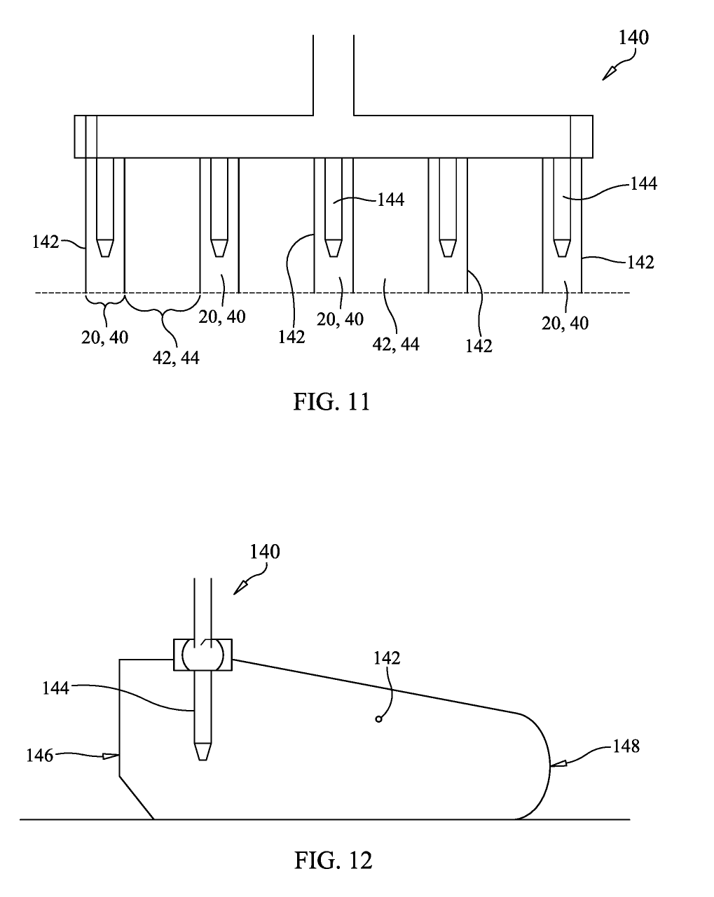

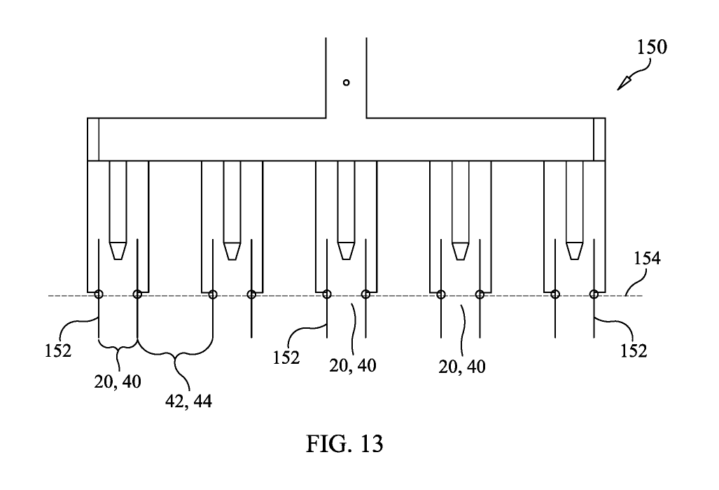

Additions to and/or deviations from the exemplary embodiments are also contemplated and are within the scope of the present disclosure. For example, as shown in FIG. 11, a portion of an exemplary herbicide application device 140, similar to the exemplary herbicide application devices 60, 70, and 80 of respective FIGS. 5, 6, and 7, and other embodiments, may include vertical plates 142 blocking or limiting herbicide drift beyond the confines of the crop stripes. That is, the vertical plates 142 may shield adjacent non-herbicide zones 42 and/or cover crop areas 44 from herbicide applied by the herbicide application device 140 via nozzles 144 or other applicators to herbicide zones 40 and/or row crop planting stripes 20. The vertical plates 142 may be supported by the herbicide application device 140 and may be positioned on either side of each of the row crop planting stripes 20 and may be adjustable to accommodate row crop planting stripes 20 of different widths. The vertical plates 142 may or may not contact the ground and may have lengths suitable to shield cover crop areas 44 from lateral drift of the herbicide, as shown in a side view of FIG. 12. That is, each vertical plate 142 may have a length extending from a front 146 to a back 148.

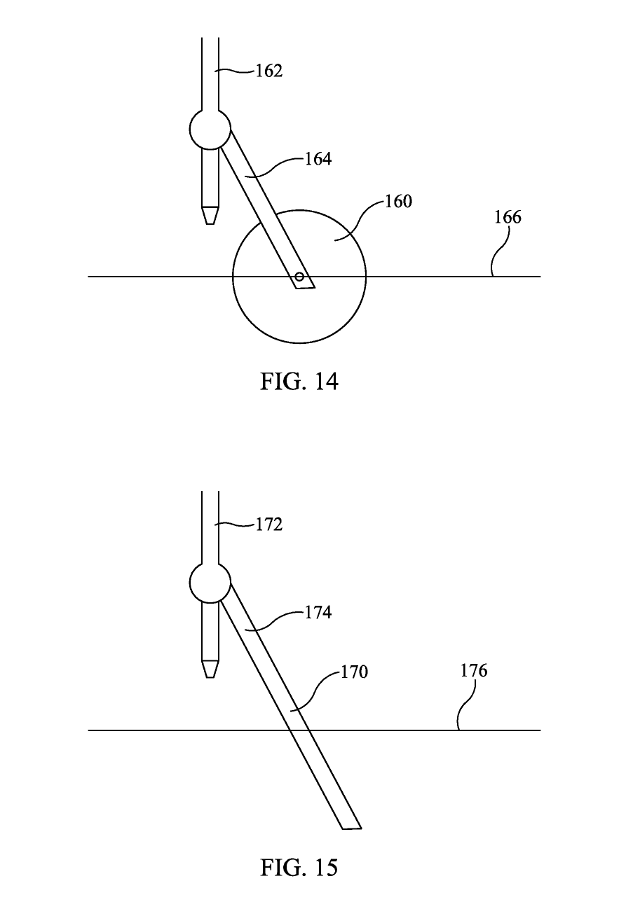

Turning now to FIGS. 13-15, an exemplary herbicide application device 150, similar to embodiments disclosed herein, may include a set of blades 152, with each blade 152 flanking the herbicide zones 40 and/or row crop planting stripes 20. That is, the spacing of the blades 152 may correspond to the widths of the herbicide zones 40. The blades 152 may be positioned underground (i.e., below a ground level 154) a predetermined amount to cut underground roots passing into the herbicide zones 40. The blades 152 may be supported by the herbicide application device 150 and may vary in diameter. The blades 152 may be flat to cut roots without disturbing the soil architecture. A circular blade 160 may be used, as shown in FIG. 14. The circular blade 160 may be supported by a herbicide tube 162 using a blade mount 164 and may be positioned at least partially below ground 166. According to another embodiment, shown in FIG. 15, a straight blade 170, supported by a herbicide tube 172 using a blade mount 174, may be used. As shown, the straight blade 170 may be positioned at least partially below ground 176.

As a substitute or addition for herbicide, heat, flame, noxious gas, laser, narrow tillage, and/or pressure may be used.

The present disclosure provides a system and method for row crop cultivation that facilitates the co-existence of a row crop and a cover crop. The cover crop provides benefits such as, for example, adding more organic matter to the soil, aerating, accumulating nitrogen, conserving the soil structure, building the soil, and suppressing weeds. The row crop can be planted without damaging the cover crop, and both the row crop and the cover crop may both be cared for and harvested as two separate crops.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A method for row crop cultivation in an agricultural plot, including:
providing a cover crop on a majority of the agricultural plot prior to planting a row crop;
creating specific crop cultivation zones, aboveground and underground, within the cover crop by applying an herbicide to the cover crop within a plurality of row crop planting stripes;
using an herbicide application device to limit application of the herbicide to the plurality of row crop planting stripes;
using a set of parallel, straight blades to cut underground roots entering the row crop planting stripes from adjacent cover crop;
planting row crop seedlings within the row crop planting stripes; and
preserving the cover crop between the plurality of row crop planting stripes during cultivation of the row crop.

2. The method of claim 1, further including sizing the row crop planting stripes to 4-6 inches wide, with 15-30 includes spaced between the row crop planting stripes.

3. The method of claim 1, further including applying the herbicide at widths corresponding to respective row crop planting stripes using a plurality of individual nozzles of the herbicide application device.

4. The method of claim 1, further including providing the herbicide to the herbicide application device using a feeder pipe.

5. The method of claim 1, further including providing the herbicide at widths corresponding to respective row crop planting stripes using a set of fibers contacting soil on or near the row crop planting stripes during use of the herbicide application device.

6. The method of claim 1, further including providing the herbicide at widths corresponding to respective row crop planting stripes using a set of wicks of the herbicide application device.

7. The method of claim 1, further including shielding the cover crop from herbicide applied to the row crop planting stripes using a shield of the herbicide application device.

8. An herbicide application device for row crop cultivation in an agricultural plot, wherein the agricultural plot includes a cover crop and designated crop cultivation zones including a plurality of row crop planting stripes, the herbicide application device including:
an implement frame supporting a feeder pipe providing herbicide to the herbicide application device from a tank or other source;
a set of parallel, straight blades supported by the implement frame configured to cut underground roots entering row crop planting stripes; and
a shield sized and configured to shield the cover crop from herbicide applied to the row crop planting stripes.

9. The herbicide application device of claim 8, wherein the row crop planting stripes are 4-6 inches wide, with 15-30 inches spaced between the row crop planting stripes.

10. The herbicide application device of claim 8, wherein the herbicide application device includes a plurality of individual nozzles configured for applying herbicide at widths corresponding to respective row crop planting stripes.

11. The herbicide application device of claim 8, wherein the herbicide application device includes a feeder pipe providing herbicide to the herbicide application device.

12. The herbicide application device of claim 8, wherein the herbicide application device includes a set of fibers contacting soil on or near the row crop planting stripes during use of the herbicide application device for applying herbicide at widths corresponding to respective row crop planting stripes.

13. The herbicide application device of claim 8, wherein the herbicide application device includes a set of wicks configured to apply herbicide at widths corresponding to respective row crop planting stripes.

14. The herbicide application device of claim 8, wherein the shield may include at least two sides, a top and an opening for receiving herbicide.

15. The herbicide application device of claim 8, wherein the shield includes a sloped front end for easing movement of the shield across the soil.

16. The herbicide application device of claim 8, wherein the shield may include one or more steps, which are positioned within the shield at a rear end of the shield and may urge herbicide entering through the opening downward toward the soil.
